(19) United States
(12) Patent Application Publication
(10) Pub. No.: US 2001/0000514 A1
(43) Pub. Date: Apr. 26, 2001

(54) Hydrocarbon/acrylic hybrid resins for use in gravure printing ink formulations

(75) Inventor: Michael D. Matzinger, Charlotte, NC (US)

Correspondence Address: Daniel B. Reece IV, Westvaco Corporation, 5255 Virginia Avenue, Post Office Box 118005, Charleston, SC, 29423-8005, US

(73) Assignee: Westvaco Corporation, New York, NY (US)

(21) Appl. No.: 09/726,184

(22) Filed: Nov. 29, 2000

Related U.S. Application Data
(63) Continuation-in-part of application No. 09/315,624, filed on May 20, 1999.

(30) Foreign Application Priority Data
May 19, 2000 (EP) 00 401 377.7

(51) Int. Cl. C09D 11/10

(52) U.S. Cl. 523/160

(57) ABSTRACT

The present invention relates to gravure printing ink systems containing improved binder resins. In particular, the invention relates to the use of hydrocarbon/acrylic hybrid resin binder compositions in gravure printing ink formulations.

1. This application is a continuation-in-part of my commonly assigned, co-pending U.S. patent application, Ser. No. 09/315,624 filed May 20, 1999, entitled “Hydrocarbon/Acrylic Hybrid Resins For Use In Gravure Printing Ink Formulations”.

### FIELD OF INVENTION

2. The present invention relates to gravure printing ink systems containing improved binder resin compositions. In particular, the invention relates to the use of hydrocarbon/acrylic hybrid resin binder compositions in gravure printing ink formulations.

### BACKGROUND OF THE INVENTION

3. A gravure printing ink generally comprises a colorant and a vehicle containing a solvent and one or more resins. These resins serve to provide the ink with adhesion, gloss, pigment dispersion and stability, rub resistance, and chemical resistance. Those skilled in the art have sought to improve upon these performance properties while at the same time reducing the costs. Hydrocarbons have been used in gravure printing inks in place of rosin resins as a less expensive alternative. However, such a replacement has occurred at the expense of performance properties. The use of rosin/hydrocarbon hybrids has been one approach for achieving a compromise between performance and cost. Examples of such hybrids include U.S. Pat. Nos. 4,056,498, 4,574,057, 5,403,391, 5,427,612, and 5,708,078.

4. The attachment of rosin to a hydrocarbon resin can result in undesired properties. For example, the color of the resulting hybrid resin can be increased. This can result in an undesired color of the final ink. Also, the attachment of rosin to a hydrocarbon resin can product a hybrid that is more prone to oxidation that the unmodified hydrocarbon resin. Oxidation of the hybrid resin can result in a change in the ink viscosity and in the color of the ink. This is particularly true when disproportionated rosin is not used. In addition, rosin possesses odorous components that can impart undesirable odors to the hybrid resin and the resulting ink.

5. There exists a need in the art of gravure printing inks for an ink formulation that is less expensive, that exhibits high performance characteristics, and that has a desired color, a stable color, a stable viscosity, and a low amount of undesirable odorous constituents.

6. Accordingly, an object of the present invention to provide hydrocarbon/acrylic hybrid resin binder compositions having properties suitable for use in formulating improved gravure printing ink formulations.

7. A further object of the present invention is to provide a hydrocarbon/acrylic hybrid resin binder composition having viscosity and solubility properties which enable its incorporation into gravure printing ink formulations.

8. Other objects, features, and advantages of the invention will be apparent from the details of the invention as more fully described and claimed.

### SUMMARY OF THE INVENTION

9. The objects of this invention are achieved by reacting carboxylic acid functionalized acrylic polymers with dicyclopentadiene and other hydrocarbon monomers to produce the desired hydrocarbon/acrylic hybrid resin binder compositions suitable for use in gravure printing ink formulations. Alternatively, the objects of this invention are also achieved by reacting carboxylic acid functionalized acrylic polymers with dicyclopentadiene and hydrocarbon resins and/or modified hydrocarbon resins to produce the desired hydrocarbon/acrylic hybrid resin binder compositions suitable for use in gravure printing ink formulations. Such gravure printing ink formulations have been found to exhibit improved color strength, gloss, and transparency characteristics, as well as reduced bronzing in the resulting pigment concentrates.

### DESCRIPTION OF THE PREFERRED EMBODIMENT

10. The hydrocarbon/acrylic hybrid resin binder composition for gravure printing ink formulations comprises the reaction product produced by reacting:

11. a) about 2% to about 63% by total weight of the reactants of dicyclopentadiene;

12. b) about 2% to about 63% by total weight of the reactants of a member selected from the group consisting of hydrocarbon monomers capable of undergoing polymerization with dicyclopentadiene and combinations thereof;

13. c) about 33% to about 96% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b); and

14. d) up to about 63% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;

15. at a temperature of from about 160°C. to about 300°C. for a time sufficient to produce the gravure ink binder composition.

16. A hydrocarbon/acrylic hybrid resin binder composition for gravure printing ink formulations comprises the reaction product produced by reacting:

17. a) about 10% to about 40% by total weight of the reactants of dicyclopentadiene;

18. b) about 10% to about 40% by total weight of the reactants of a member selected from the group consisting of hydrocarbon monomers capable of undergoing polymerization with dicyclopentadiene and combinations thereof;

19. c) about 40% to about 80% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b); and

20. d) up to about 40% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;

21. at a temperature of from about 220°C. to about 280°C. for a time sufficient to produce the gravure ink binder composition.

22. Another hydrocarbon/acrylic hybrid resin binder composition for gravure printing ink formulations which is an object of the present invention comprises the reaction product produced by:

23. 1) reacting

24. a) about 2% to about 63% by total weight of the reactants of dicyclopentadiene;

25. b) about 2% to about 63% by total weight of the reactants of a member selected from the group consisting of hydrocarbon monomers capable of undergoing polymerization with dicyclopentadiene and combinations thereof; and

26. c) about 33% to about 96% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b);

27. at a temperature of from about 160°C. to about 300°C. for a time sufficient to produce a resin composition; and

28. 2) further reacting:

29. a) about 35% to about 98% by total weight of the reactants of said resin composition, and

30. b) about 2% to about 65% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;

31. at a temperature of from about 160°C. to about 300°C. for a time sufficient to produce the gravure ink binder composition.

32. A preferred hydrocarbon/acrylic hybrid resin binder composition for gravure printing ink formulations comprises the reaction product produced by:

33. 1) reacting

34. a) about 10% to about 40% by total weight of the reactants of dicyclopentadiene;

35. b) about 10% to about 40% by total weight of the reactants of a member selected from the group consisting of hydrocarbon monomers capable of undergoing polymerization with dicyclopentadiene and combinations thereof; and

36. c) about 40% to about 80% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b);

37. at a temperature of from about 220°C. to about 280°C. for a time sufficient to produce a resin composition, and

38. 2) further reacting

39. b) about 50% to about 80% by total weight of the reactants of said resin composition, and

40. b) about 20% to about 50% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;

41. at a temperature of from about 220°C. to about 280°C. for a time sufficient to produce the gravure ink binder composition.

42. A further hydrocarbon/acrylic hybrid resin binder composition for gravure printing ink formulations comprises the reaction product produced by reacting:

43. a) about 2% to about 63% by total weight of the reactants of dicyclopentadiene;

44. b) about 2% to about 63% by total weight of the reactants of a member selected from the group consisting of hydrocarbon resins, modified hydrocarbon resins, and combinations thereof;

45. c) about 33% to about 96% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b); and

46. d) up to about 63% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;

47. at a temperature of from about 140°C. to about 300°C. for a time sufficient to produce the gravure ink binder composition.

48. A preferred hydrocarbon/acrylic hybrid resin binder composition for gravure printing ink formulations comprises the reaction product produced by reacting:

49. a) about 10% to about 40% by total weight of the reactants of dicyclopentadiene;

50. b) about 10% to about 40% by total weight of the reactants of a member selected from the group consisting of hydrocarbon resins, modified hydrocarbon resins, and combinations thereof;

51. c) about 40% to about 80% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b); and

52. d) up to about 40% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;

53. at a temperature of from about 180°C. to about 260°C. for a time sufficient to produce the gravure ink binder composition.

54. A further hydrocarbon/acrylic hybrid resin binder composition for gravure printing ink formulations comprises the reaction product produced by:

55. 1) reacting

56. a) about 2% to about 63% by total weight of the reactants of dicyclopentadiene;

57. b) about 2% to about 63% by total weight of the reactants of a member selected from the group consisting of hydrocarbon resins, modified hydrocarbon resins, and combinations thereof; and

58. c) about 33% to about 96% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b);

59. at a temperature of from about 140°C. to about 300°C. for a time sufficient to produce a resin composition; and

60. 2) further reacting:

61. a) about 35% to about 98% by total weight of the reactants of said resin composition, and

62. b) about 2% to about 65% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;

63. at a temperature of from about 140°C. to about 300°C. for a time sufficient to produce the gravure ink binder composition.

64. A preferred hydrocarbon/acrylic hybrid resin binder composition for gravure printing ink formulations comprises the reaction product produced by:

65. 1) reacting

66. a) about 10% to about 40% by total weight of the reactants of dicyclopentadiene;

67. b) about 10% to about 40% by total weight of the reactants of a member selected from the group consisting of hydrocarbon resins, modified hydrocarbon resins, and combinations thereof; and

68. c) about 40% to about 80% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b);

69. at a temperature of from about 180°C. to about 260°C. for a time sufficient to produce a resin composition, and

70. 2) further reacting

71. a) about 50% to about 80% by total weight of the reactants of said resin composition, and

72. b) about 20% to about 50% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;

73. at a temperature of from about 180°C. to about 260°C. for a time sufficient to produce the gravure ink binder composition.

74. Depending upon the characteristics desired, the hydrocarbon/acrylic resin gravure ink binder compositions of the present invention can be formed via two differing methods. In one method, hydrocarbon/acrylic resins are formed by heating a mixture of hydrocarbon monomers (wherein one of the monomers is dicyclopentadiene), one or more acrylic resins and, optionally, specified additional chemical compounds to temperatures of from about 160°C. to about 300°C. (preferably from about 220°C. to about 280°C.). The weight ratio of acrylic polymer to hydrocarbon monomers usually is about 2:1 to 1:45. The components are charged to a reactor which is then sealed and heated to a temperature within the desired range. The procedure generally is performed under an inert atmosphere by purging the charged reactor with nitrogen prior to sealing it. As the mixture is heated, an autogenous pressure of between 70 and 160 psig is usually generated. After maximizing, this pressure generally falls to between 40 and 70 psig as the polymerization proceeds. The reaction mixture is maintained at a temperature within the desired range under pressure for a period sufficient to achieve a hydrocarbon/acrylic hybrid resin possessing the desired properties. Typically a time of at least three hours is employed. Following this, the reactor is vented to reduce the pressure to 0 psig. Next, unreacted hydrocarbon monomers and inert compounds that would depress the softening point of the resin and give it an offensive odor are distilled from the reaction mixture. The removal of these materials is promoted by sparging the resin with nitrogen. Nitrogen is bubbled through the reaction mixture generally at a rate of 0.001 to 0.01 lb of N₂ per lb of reactants per hour. The length of this step is dependent on the desired properties of the resin but typically is conducted from one to ten hours.

75. Alternatively, in the second method hydrocarbon/acrylic resins of the present invention are formed by heating a mixture of dicyclopentadiene, one or more hydrocarbon-based resins, one or more acrylic resins and, optionally, specified additional chemical compounds to temperatures of from about 140°C. to about 300°C. (preferably from about 180°C. to about 260°C.). The weight ratio of acrylic polymer to dicyclopentadiene and hydrocarbon resins usually is about 10:1 to 1:30. The components are charged to a reactor which is then heated to a temperature within the desired range. The procedure generally is performed at atmospheric pressure; however, the reaction can be performed at an autogenous pressure. The reaction mixture is maintained at a temperature within the desired range for a period sufficient to bind the dicyclopentadiene and acrylic polymers together and to achieve a hydrocarbon/acrylic hybrid resin binder having the desired properties. Typically a period of time of at least two hours is employed.

76. Unexpectedly, the method by which the hydrocarbon/acrylic hybrid resin binder is prepared impacts the properties of the resin. That is, a different resin binder is obtained when the method of preparation is changed. Compared to the resins made according to the procedure of the first method, the resins of the second method are lower in softening point and molecular weight.

77. Hydrocarbon monomers suitable for producing the resin binders must be capable of undergoing polymerization with dicyclopentadiene. The hydrocarbon monomer typically employed to make the hydrocarbon/acrylic resin is a technical grade dicyclopentadiene containing from about 75 to 85% dicyclopentadiene. Examples of such materials that are commercially available are DCPD 101 (a product of Lyondell Petrochemical) and DCP-80P (a product of Exxon). Other components in the dicyclopentadiene are inert hydrocarbons (such as toluene, xylenes and saturated hydrocarbons with from 4 to 6 carbons), and various codimers and cotrimers formed by the Diels-Alder condensation of butadiene, cyclopentadiene, methylcyclopentadiene, and acyclic pentadienes.

78. The above-noted hydrocarbon monomers may be employed in thermal polymerization reactions to produce hydrocarbon resins and modified hydrocarbon resins suitable for use in producing the resin binders.

79. Likewise, aromatic hydrocarbons having a vinyl group conjugated to the aromatic ring may be employed to produce hydrocarbon resins and modified hydrocarbon resins suitable for use in producing the resin binders. The vinyl aromatic compounds are incorporated into the growing dicyclopentadiene containing polymer by free radical addition to the vinyl group. Examples of such aromatic monomers are styrene, vinyl toluene, a-methyl styrene, β-methyl styrene, indene and methyl indene. Typically, hydrocarbon mixtures that contain from 50 to 100% of such compounds are used. Other components found in these mixtures are usually inert aromatic compounds, e.g., toluene, xylenes, alkylbenzenes and naphthalene. A commercially available example of such a mixture is LRO-90® (a product of Lyondell Petrochemical). A typical analysis of this materials is: xylene (1-5%), styrene (1-10%), α-methylstyrene (1-3%), β-methylstyrene (1-5%), methylindene (5-15%), trimethylbenzenes (1-20%), vinyltoluene (1-30%), indene (1-15%) and naphthalene (1-5%).

80. When incorporating vinyl aromatic monomers to produce hydrocarbon resins or modified hydrocarbon resins, the procedure for preparing the resin is the same. The vinyl aromatic component is added along with the dicyclopentadiene and other hydrocarbon monomer. The aromatic component is added to the reaction mixture in an amount less than the dicyclopentadiene used. Generally, the aromatic component is employed in an amount no greater than 30% by weight of the total reaction mixture. Preferably, the vinyl aromatic component is used from about 5 to 20% of the total reagent charge.

81. For both synthetic methods for producing the resin binders, the amount of dicyclopentadiene monomer used in the preparation of the hydrocarbon/acrylic resin must be sufficient so as to provide at least one or more sites for the acrylic polymer to attach. Likewise, the acrylic polymer used in each method must have a sufficient number of acid sites so that at least one reaction with a dicyclopentadiene polymer can occur.

82. Although the mechanism of the reaction is not completely understood, it appears that an important aspect of the acrylic polymer is that the polymer possess: a) one or more carboxylic acid and/or carboxylic acid-precursor groups (i.e., be carboxylic acid functionalized), or b) that the polymer be both carboxylic acid functionalized and hydroxyl functionalized (i.e., also possess one or more hydroxyl and/or hydroxyl-precursor groups). These chemical characteristics permit the acrylic polymer to react in a cycloaddition reaction with the norbornyl-type double bonds in the dicyclopentadiene resin. In this way the acrylic polymer is chemically bound (grafted) to the hydrocarbon polymer, thereby yielding a hydrocarbon/acrylic graft copolymer.

83. The mechanism of grafting employed in the present invention is the cycloaddition of a carboxyl group on a preformed acrylic polymer across a double bond (e.g., norbornyl double bonds) of the hydrocarbon resin. The attachment of the acrylic resin occurs through an ester linkage in the cycloaddition graft, thereby allowing the acrylic chains to be attached to the hydrocarbon somewhere at mid-chain of the acrylic resin. The employment of this cycloaddition mechanism affords the user a great deal of flexibility in designing desired graft polymer structures.

84. Polymers that contain more than one acid group or hydroxyl group may be used and therefore are capable of reacting with more than one norbornyl-type double bond and acting as cross-linking agents between hydrocarbon polymer molecules. Furthermore, because the number of acid groups or hydroxyl groups on the acrylic polymer can be varied by changing the monomer composition, the crosslinking ability of the polymer can exceed that of modified rosin resins such as fumaric acid-adducted phenolic rosin resins, modified fatty acids such as maleic-anhydride-adducted linoleic acid, polyols such as pentaerythritol and sorbitol, polyamines such as 2-methylpentamethylene and hexamethylenediamine, polyaziridines such as IONAC® PFAZ-322 (supplied by Sybron Chemicals Inc.)] DYTEK® A (supplied by from DuPont Company) and IONAC® PFAZ-322 (supplied by from Sybron Chemicals Inc.), and alkanolamines such as diethanolamine. The use of acrylic polymers with multiple acid groups or hydroxyl groups allows the preparation of hydrocarbon/acrylic resins with blends of viscosity, solubility and softening point properties that cannot be obtained by using resins with one or several acid groups or hydroxyl groups. For example, the use of multiple acid group-containing polymers or multiple hydroxyl group-containing polymers allows the synthesis of hydrocarbon/acrylic resins of molecular weight, viscosity, softening point, and efflux cup dilution properties higher than achievable using materials such as rosin and fatty acid and their derivatives.

85. Alcohols which are suitable for use in producing the hydrocarbon/acrylic gravure ink binder compositions are members selected from the group consisting of alcohols capable of undergoing an insertion reaction across a norbornyl site, alcohols capable of undergoing an esterification reaction with an acid group, alcohols capable of undergoing an esterification reaction with an acid equivalent functional group, and combinations thereof. Alkyl amines which are suitable for use in producing the hydrocarbon/acrylic gravure ink binder compositions are members selected from the group consisting of alkyl amines capable of undergoing an insertion reaction across a norbornyl site, alkyl amines capable of undergoing an esterification reaction with an acid group, alkyl amines capable of undergoing an esterification reaction with an acid equivalent functional group, and combinations thereof. Where desired, the molecular weight of the hydrocarbon/acrylic resin can be increased by treating the hydrocarbon/acrylic resin with a compound containing one or more functionalities from the group consisting of polyols, polyamines, polyaziridines, alkanolamines, polysulfides, and alkanolsulfides. Examples of polyols suitable for use in the present methods include pentaerythritol, glycerin, ethylene glycol, sorbitol, and the like. Examples of suitable polyamines include 2-methylpentamethylenediamine, bis(hexamethylene) triamine, 1,3-pentanediamine, and the like. Examples of suitable polyaziridines include IONAC® PFAZ-322 (supplied by Sybron Chemicals Inc.) and similar compounds. Examples of suitable polysulfides include glycerol dimercaptoacetate, pentaerythritol tetra(3-mercaptopropionate), trimethylolpropane trithioglycolate, polyethylene glycol dimercaptoacetate, and the like. Examples of suitable alkanolsulfides include glycerol monothioglycolate, monoethanolamine thioglycolate, 1-thioglycerol, and the like.

86. Specific examples of preferred carboxylic acid-functionalized acrylic polymers usable herein include a copolymer of styrene or a styrene derivative with acrylic acid or methacrylic acid. Styrene monomers usable herein include styrene, and further, styrene derivatives such as methylstyrene, dimethylstyrene, trimethylstyrene, α-chlorostyrene, α-methylstyrene, and the like. The copolymers may contain other monomers. Examples of other monomers include -unsaturated monomers including vinyl halides, vinyl esters, mono vinylidene aromatics, α,β-unsaturated carboxylic acids and esters thereof, -unsaturated dicarboxylic anhydrides, and mixtures thereof, and other monomers copolymerizable with styrene and (meth)acrylic acid. Polymerization methods are not particularly limited, and polymers having various monomer ratios are commercially available and may be used in the present invention.

87. Commercially available carboxylic acid-functionalized acrylic polymers include JONREZ® H-2700, H-2701, H-2702, and H-2704 (supplied by the Westvaco Corp.), JONCRYL® 678, 682, and 690 (supplied by S. C. Johnson, Inc.), MOREZ® 101 and 300 (supplied by Morton Int., Inc.), and VANCRYL® 65 and 68 (supplied by Air Products and Chemicals, Inc.). Commercially available hydroxyl-functionalized acrylic polymers include JONREZ® H-2703 (supplied by the Westvaco Corp.) and JONCRYL® 587 (supplied by S. C. Johnson, Inc.).

88. In a further embodiment of the invention, the hydrocarbon/acrylic resin may be reacted with α,β-unsaturated carboxylic acids, α,β-unsaturated carboxylic diacids, α,β-unsaturated carboxylic anhydrides, and the like. Examples of such carboxylic compounds which are suitable for use in producing the hydrocarbon/acrylic gravure ink binder compositions of the present invention include those which are capable of undergoing an insertion reaction across a norbornyl site and/or an esterification reaction with an acid group or an acid equivalent functional group. Other carboxylic compounds which are suitable for use include those which are capable of Diels-Alder addition or ene reaction. Specific examples of such compounds include maleic anhydride, fumaric acid, itaconic acid, itaconic anhydride, crotonic acid, acrylic acid, methacrylic acid, and the like. These compounds react with the resin by a Diels-Alder addition or ene reaction, thus incorporating without loss of their carboxylic acid or anhydride functions. The reaction can be performed in the temperature range of 180-240°C., with the a range of 190-210°C. preferred. In general, from about 2 wt. % to about 15 wt. % of the α,β-unsaturated carboxylic acids, diacids or anhydrides can be added to the reaction mixture, but it is preferred that from about 4 wt. % to about 8 wt. % be used.

89. In a further embodiment of the invention, an α,β-unsaturated carboxylic acid, α,β-unsaturated carboxylic diacid, or α,β-unsaturated carboxylic anhydride can be incorporated into the hydrocarbon/acrylic resin during the polymerization reaction, thus incorporating without loss of their carboxylic acid or anhydride functions. Examples of such compounds are given in the previous paragraph. In general, from about 2 wt. % to about 40 wt. % of the α,β-unsaturated carboxylic acids, α,β-unsaturated carboxylic diacids, or α,β-unsaturated carboxylic anhydrides can be added to the reaction mixture, but it is preferred that from about 4 wt. % to about 15 wt. % be used.

90. In a further embodiment of the invention, the hydrocarbon/acrylic resin may be reacted with fatty acids, fatty acid compounds, rosin acids, and/or rosin resins. Examples of such compounds which are suitable for use in producing the hydrocarbon/acrylic gravure ink binder compositions of the present invention include those which are capable of undergoing an insertion reaction across a norbornyl site and/or an esterification reaction with an acid group or an acid equivalent functional group.

91. Fatty acids which are suitable for use in the present invention include, but are not limited to, the following: unsaturated fatty acids, saturated fatty acids, dimerized fatty acids, modified fatty acids, and combinations thereof. Suitable fatty acid compounds include the Diels-Alder cyclo-adducts and the ene-addition reaction products of unsaturated and polyunsaturated fatty acids with acrylic acid, acrylic acid derivatives, fumaric acid, and/or maleic anhydride.

92. In a further embodiment of the invention, rosin and rosin-based resins can be incorporated into the hydrocarbon/acrylic resin either during or after the polymerization reaction. Rosins suitable for this invention include tall oil rosin, gum rosin and wood rosin. Synthetic sources of these rosin acids may also be used. The modification of rosin with components such as phenols, α,β-unsaturated carboxylic acid, and polyols to produce rosin-based resins is a well established method for producing rosin-based resins. Examples of such suitable rosin-based resins are the JONREZ® RP-300, SM-700, IM-800, and HC-900 resin series (supplied by the Westvaco Corp.). The high acid values common in rosins may be lowered by reacting them with zinc oxide, calcium acetate, or similar compounds to produce metallic resinates.

93. In a further embodiment of the invention, mononuclear phenols, polynuclear phenols, or phenol-based resins (i.e., novolacs or resoles) can be incorporated into the hydrocarbon/acrylic resin either during or after the polymerization reaction. Examples of such phenolic compounds which are suitable for use in producing the hydrocarbon/acrylic gravure ink binder compositions of the present invention include those which are capable of undergoing an insertion reaction across a norbornyl site and/or an esterification reaction with an acid group or an acid equivalent functional group. These phenolic compounds can also be reacted with suitable aldehydes and/or aldehyde acetals either prior to or following the insertion reaction or esterification reaction. Among the phenolic compounds that can be used to modify the resin are phenol, bisphenol-A, para-tert-butylphenol, para-octylphenol, para-nonylphenol, para-dodecylphenol, para-phenylphenol, novolac resins such as HRJ-1166, HRJ-1367, SP-134, SP-560, SP-1068, SP-1077, and SRF-1524 (all supplied by Schenectady International, Inc.), resole resins, and mixtures thereof. Aldehydes which are suitable for use in the present invention include, but are not limited to, the following: paraformaldehyde, formaldehyde, and combinations thereof.

94. Resins suitable for use in this invention are characterized by acid number (ASTM D465-92) and softening point (ASTM E28-92). The units for acid number as reported here are mg KOH/gram of resin. Suitable acid numbers are from about 20 to about 100 for gravure printing inks, preferably from about 40 to about 80. Suitable softening points are from about 100°C. to about 210°C. for gravure printing inks, preferably from about 160°C. to about 180°C.

95. The resins of this invention suitable for use in solvent-based gravure printing inks are further characterized by efflux cup dilution. The efflux cup dilution value is the amount of toluene per 100 grams of resin required to reach a viscosity of 18 sec with a #2 Shell cup at 25°C. Resins with an efflux cup dilution value from about 20 to about 300 mL are suitable for use in gravure printing inks. The above described properties of the resins of this invention can be controlled by the composition of the resin and the processing conditions.

96. The gravure printing ink compositions of the instant invention are prepared by mixing together the hydrocarbon/acrylic hybrid resin binder, a colorant, and a high-boiling hydrocarbon solvent. Other resins, dispersants, surfactants, and cosolvents may be added.

97. Where desired, the gravure printing ink formulation may include a resinate in addition to a pigment and the present binder composition. Suitable resinates for use in conjunction with the present binder may be prepared by metallization (i.e., the production of metal salts) of the hydrocarbon/acrylic hybrid resin binder with a member selected from the group consisting of metal oxides, metal hydroxides, metal acetates, metal carbonates, and combinations thereof.

98. The colorant generally is a pigment; specifically, a common pigment used in gravure printing inks well-known to those of ordinary skill in the printing art. The pigment may be predispersed using equipment designed for this purpose such as a ball mill or shot mill. A grind resin can be used during this operation to improve and maintain pigment dispersion. The hydrocarbon/acrylic hybrid resin of this invention may be used in such an application. In addition to pigments, dyes may also be used. The amount of colorant present in the instant invention is generally from about 1% to about 20%; preferably from about 2% to about 10%.

99. The high-boiling solvent typically used is toluene. However, xylenes, benzenes, and napthas may also be used. The amount of solvent contained in the ink composition is adjusted to obtain the desired viscosity, rheological, evaporation, and print qualities.

100. The following examples are provided to further illustrate the present invention and are not to be construed as limiting the invention in any manner. All parts are by weight unless otherwise stated.

### EXAMPLE 1

101. Into a one-liter autoclave reactor were charged 377 parts of DCPD 101® (a dicyclopentadiene supplied by Lyondell Petrochemical), 169 parts LRO-90® (a hydrocarbon mixture containing vinyl aromatic compounds supplied by Lyondell Petrochemical), 52 parts of SAABA (a polymer comprised of 83.5 wt. % styrene, 6.5 wt % acrylic acid, and 10 wt. % butyl acrylate and having an acid number of 47), and 52 parts maleic anhydride. The charged autoclave was purged with nitrogen and sealed. The reaction mixture was heated to 265°C. over a 60 minute period and was maintained at 260°C. for four hours. The reactor was then vented carefully, and the molten resin was poured into an aluminum pan and was allowed to cool.

102. Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 260°C. At 260°C., the nitrogen inlet tube was immersed in the liquid resin and the nitrogen flow was adjusted to a rate of approximately 400 ml/min. The resin was sparged for four hours and then discharged into an aluminum pan.

103. The resulting hydrocarbon/acrylic resin binder had an acid number of 46, a Ring and Ball softening point of 152°C., and a efflux cup dilution (#2 Shell Cup, 25°C., 18 sec end point) of 42 mL.

104. A 50 wt. % solution of the resin was prepared by dissolving 152 parts of the resin in toluene. This solution was placed in a 500-mL, four-neck, round-bottom flask equipped with an electric heating mantle, overhead stirrer, thermocouple, nitrogen inlet tube, and Barret trap attached to a water-cooled condenser. To this solution was added 3 parts lime. The contents were heated to 270°C. and water was removed. The resulting resinate had a viscosity of 23 line-to-line seconds, a capillary melt point of 182°C., and a toluene dilution of 130 mL (#2 Shell Cup, 25°C., 18 sec end point). Addition of a pigment dispersion to this toluene solution provides a gravure printing ink with excellent print performance.

### EXAMPLE 2

105. Into a one-liter autoclave reactor were charged 455 parts of DCPD 101® (a dicyclopentadiene supplied by Lyondell Petrochemical), 143 parts LRO-90® (a hydrocarbon mixture containing vinyl aromatic compounds supplied by Lyondell Petrochemical), 26 parts of SAAEHA (a polymer comprised of 60 wt. % styrene, 20 wt. % acrylic acid, and 20 wt. % 2-ethyl hexyl acrylate and having an acid number of 128), and 26 parts maleic anhydride. The charged autoclave was purged with nitrogen and sealed. The reaction mixture was heated to 265°C. over a 30 minute period and was maintained at 260°C. for seven hours. The reactor was then vented carefully, and the molten resin was poured into an aluminum pan and was allowed to cool.

106. Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 260°C. At 260°C., the nitrogen inlet tube was immersed in the liquid resin and the nitrogen flow was adjusted to a rate of approximately 400 ml/min. The resin was sparged for four hours and then discharged into an aluminum pan.

107. The resulting hydrocarbon/acrylic resin binder had an acid number of 23, a Ring and Ball softening point of 162°C., and a efflux cup dilution (#2 Shell Cup, 25°C., 18 sec end point) of 42 mL. Conversion of this resin into a resinate (via the method described in Example 1) followed by addition of a pigment dispersion, provides a gravure printing ink with excellent print performance.

### EXAMPLE 3

108. Into a one-liter, round-bottom, five-neck flask equipped with a electric heating mantle, overhead stirrer, thermocouple, nitrogen inlet tube, and Barret trap attached to a water-cooled condenser was charged 225 parts of the resin of Example 1. The resin was heated to a temperature of 200°C. under a nitrogen blanket and then 11.3 parts diethylene glycol was added. The temperature was increased to 230°C. and was maintained for a period of six hours. The resin was sparged for 30 minutes and then discharged into an aluminum pan.

109. The resulting hydrocarbon/acrylic resin binder had an acid number of 26, a Ring and Ball softening point of 170°C., and a efflux cup dilution (#2 Shell Cup, 25°C., 18 sec end point) of 84 mL. Conversion of this resin into a resinate (via the method described in Example 1) followed by addition of a pigment dispersion, provides a gravure printing ink with excellent print performance.

### EXAMPLE 4

110. Into a one-liter autoclave reactor were charged 350 parts of DCPD 101® (a dicyclopentadiene supplied by Lyondell Petrochemical), 150 parts LRO-90® (a hydrocarbon mixture containing vinyl aromatic compounds supplied by Lyondell Petrochemical), 100 parts JONREZ® H-2702 (a styrene/acrylic polymer having an acid number of 200 supplied by the Westvaco Corp.), and 25 parts NEODENE® 16 (a 1-hexadecene supplied by Shell Chemical Co.). The charged autoclave was purged with nitrogen and sealed. The reaction mixture was heated to 265°C. over a 45 minute period and was maintained at 260°C. for five hours. The reactor was then vented carefully, and the molten resin was poured into an aluminum pan and was allowed to cool.

111. Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 260°C. At 260°C., the nitrogen inlet tube was immersed in the liquid resin and the nitrogen flow was adjusted to a rate of approximately 400 ml/min. The resin was sparged for 30 minutes and then discharged into an aluminum pan.

112. The resulting hydrocarbon/acrylic resin binder had an acid number of 7 and a Ring and Ball softening point of 130°C. The resin was insoluble in alkaline refined linseed oil and in MAGIESOL® 47 oil (a hydrocarbon solvent supplied by Magie Brothers Oil Co.). Conversion of this resin into a resinate (via the method described in Example 1) followed by addition of a pigment dispersion, provides a gravure printing ink with excellent print performance.

### EXAMPLE 5

113. Into a 500-mL, round-bottom, four-neck flask equipped with a electric heating mantle, overhead stirrer, thermocouple, nitrogen inlet tube, and Barret trap attached to a water-cooled condenser was charged 200 parts of the resin of Example 4 and 20 parts maleic anhydride. The temperature was increased to 200°C. and was maintained for three hours. Then, 10 parts SP 134 (an alkylphenol-formaldehyde thermosetting resin supplied by Schenectady International Inc.) was added. After a period of one hour, the resin was discharged into an aluminum pan.

114. The resulting hydrocarbon/acrylic resin binder had an acid number of 49, a Ring and Ball softening point of 175°C., and a efflux cup dilution (#2 Shell Cup, 25°C., 18 sec end point) of 132 mL. Conversion of this resin into a resinate (via the method described in Example 1) followed by addition of a pigment dispersion, provides a gravure printing ink with excellent print performance.

### EXAMPLE 6

115. Into a one-liter autoclave reactor were charged 375 parts of DCPD 101® (a dicyclopentadiene supplied by Lyondell Petrochemical), 150 parts LRO-90® (a hydrocarbon mixture containing vinyl aromatic compounds supplied by Lyondell Petrochemical), and 100 parts JONREZ® H-2702 (a styrene/acrylic polymer having an acid number of 200 supplied by the Westvaco Corp.). The charged autoclave was purged with nitrogen and sealed. The reaction mixture was heated to 265°C. over a 90 minute period and was maintained at 260°C. for four hours. The reactor was then vented carefully, and the molten resin was poured into an aluminum pan and was allowed to cool.

116. Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 260°C. At 260°C., the nitrogen inlet tube was immersed in the liquid resin and the nitrogen flow was adjusted to a rate of approximately 400 ml/min. The resin was sparged for one hour and then discharged into an aluminum pan.

117. The resulting hydrocarbon/acrylic resin had an acid number of 5 and a Ring and Ball softening point of 140°C. The resin was insoluble in alkaline refined linseed oil and in MAGIESOL® 47 oil (a hydrocarbon solvent supplied by Magie Brothers Oil Co.). Conversion of this resin into a resinate (via the method described in Example 1) followed by addition of a pigment dispersion, provides a gravure printing ink with excellent print performance.

### EXAMPLE 7

118. Into a 500-mL, round-bottom, four-neck flask equipped with a electric heating mantle, overhead stirrer, thermocouple, nitrogen inlet tube, and Barret trap attached to a water-cooled condenser was charged 150 parts of the resin of Example 6 and 5 parts maleic anhydride. The resin was heated to a temperature of 180°C. under a nitrogen blanket and then 20 parts Rosin SS (a tall oil rosin supplied by the Westvaco Corp.) was added. The temperature was increased to 275°C. and was maintained for a period of three hours. The temperature was decreased to 210°C. and then 5.5 grams of pentaerythritol was added. The temperature was increased to 275°C. and was maintained for 90 minutes. The resin was then discharged into an aluminum pan.

119. The resulting hydrocarbon/acrylic resin binder had an acid number of 64, a Ring and Ball softening point of 150°C., and a efflux cup dilution (#2 Shell Cup, 25°C., 18 sec end point) of 86 mL. Conversion of this resin into a resinate (via the method described in Example 1) followed by addition of a pigment dispersion, provides a gravure printing ink with excellent print performance.

### EXAMPLE 8

120. Into a one-liter autoclave reactor were charged 1401 parts of DCPD 101® (a dicyclopentadiene supplied by Lyondell Petrochemical), 602 parts LRO-90® (a hydrocarbon mixture containing vinyl aromatic compounds supplied by Lyondell Petrochemical), 120 parts of NEODENE® 16 (a 1-hexadecene supplied by Shell), and 100 parts JONREZ® H-2701 (a styrene/acrylic polymer having an acid number of 206 supplied by the Westvaco Corp.). The charged autoclave was purged with nitrogen and sealed. The reaction mixture was heated to 260°C. over a 90 minute period and was maintained at 260°C. for five hours. The reactor was then vented carefully, and the molten resin was poured into an aluminum pan and was allowed to cool.

121. Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 220°C. At 220°C., the nitrogen inlet tube was immersed in the liquid resin and the nitrogen flow was adjusted to a rate of approximately 400 ml/min. The resin was sparged for two hours and then discharged into an aluminum pan.

122. The resulting hydrocarbon/acrylic resin binder had an acid number of 4, a glass transition temperature of 2°C., a weight average molecular weight of 5960 daltons, a Brookfield viscosity at 135°C. of 4780 cP, and a Ring and Ball softening point of 79°C. Conversion of this resin into a resinate (via the method described in Example 1) followed by addition of a pigment dispersion, provides a gravure printing ink with excellent print performance.

### EXAMPLE 9

123. Into a one-liter autoclave reactor were charged 1708 parts of DCPD 101® (a dicyclopentadiene supplied by Lyondell Petrochemical), 752 parts LRO-90® (a hydrocarbon mixture containing vinyl aromatic compounds supplied by Lyondell Petrochemical), and 150 parts NEODENE® 16 (a 1-hexadecene supplied by Shell Chemical Co.). The charged autoclave was purged with nitrogen and sealed. The reaction mixture was heated to 260°C. over a two hour period and was maintained at 260°C. for five hours. The reactor was then vented carefully, and the molten resin was poured into an aluminum pan and was allowed to cool.

124. Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 220°C. At 220°C., the nitrogen inlet tube was immersed in the liquid resin and the nitrogen flow was adjusted to a rate of approximately 400 ml/min. The resin was sparged for two hours and then discharged into an aluminum pan.

125. The resulting hydrocarbon/acrylic resin binder had a glass transition temperature of 3°C., a weight average molecular weight of 1290 daltons, a Brookfield viscosity at 135°C. of 455 cP, and a Ring and Ball softening point of 54°C.

126. To a one-liter, four-neck, round-bottom flask equipped with an electric heating mantle, overhead stirrer, thermocouple, nitrogen inlet tube, and Barret trap attached to a water-cooled condenser was added 400 parts of the resin and 126 parts JONREZ® H-2701 (a polymer having an acid number of 210 supplied by the Westvaco Corp.). The contents of the flask were heated to a temperature of 220°C. After five hours at 220°C., the resulting resin was collected in an aluminum pan. The resin had an acid number of 32 and a softening point of 146°C. Conversion of this resin into a resinate, as described in Example 1, followed by addition of a pigment dispersion, provides a gravure printing ink with excellent print performance.

### EXAMPLE 10

127. To a one-liter, four-neck, round-bottom flask equipped with an electric heating mantle, overhead stirrer, thermocouple, nitrogen inlet tube, and Barret trap attached to a water-cooled condenser were added 350 parts of the resin described in Example 8 and 40 parts maleic anhydride. The contents of the flask were heated to a temperature of 190°C. After five hours at 190°C., the resulting hydrocarbon/acrylic resin was collected in an aluminum pan. The resin had an acid number of 60, a weight average molecular weight of 7970 daltons, and a softening point of 121°C. Conversion of this resin into a resinate, as described in Example 1, followed by addition of a pigment dispersion, provides a gravure printing ink with excellent print performance.

### EXAMPLE 11

128. To a one-liter, four-neck, round-bottom flask equipped with an electric heating mantle, overhead stirrer, thermocouple, nitrogen inlet tube, and Barret trap attached to a water-cooled condenser were added 350 parts of the resin described in Example 8 and 40 parts maleic anhydride. The contents of the flask were heated to a temperature of 190°C. After four hours at 190°C., five parts of diethylene glycol was added and the temperature was increased to 260°C. After two hours at 260°C., the resulting hydrocarbon/acrylic resin was collected in an aluminum pan. The resin had an acid number of 53, a weight average molecular weight of 15.5K daltons, and a softening point of 140°C. Conversion of this resin into a resinate, as described in Example 1, followed by addition of a pigment dispersion, provides a gravure printing ink with excellent print performance.

### EXAMPLE 12

129. Into a one-liter autoclave reactor were charged 1399 parts of DCPD 101® (a dicyclopentadiene supplied by Lyondell Petrochemical), 603 parts LRO-90® (a hydrocarbon mixture containing vinyl aromatic compounds supplied by Lyondell Petrochemical), 120 parts of NEODENE® 16 (a 1-hexadecene supplied by Shell Chemical Co.), and 402 parts JONREZ® H-2703 (a styrene/acrylic polymer having a hydroxyl value of 90 supplied by the Westvaco Corp.). The charged autoclave was purged with nitrogen and sealed. The reaction mixture was heated to 260°C. over a 90 minute period and was maintained at 260°C. for five hours. The reactor was then vented carefully, and the molten resin was poured into an aluminum pan and was allowed to cool.

130. Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 220°C. At 220°C., the nitrogen inlet tube was immersed in the liquid resin and the nitrogen flow was adjusted to a rate of approximately 400 ml/min. The resin was sparged for two hours and then discharged into an aluminum pan.

131. The resulting hydrocarbon/acrylic resin binder had a weight average molecular weight of 1760 daltons and a Ring and Ball softening point of 81°C. Conversion of this resin into a resinate, as described in Example 1, followed by addition of a pigment dispersion, provides a gravure printing ink with excellent print performance.

132. While the invention has been described and illustrated herein by references to various specific materials, procedures, and examples, it is understood that the invention is not restricted to the particular materials, combination of materials, and procedures selected for that purpose. Many modifications and variations of the present invention will be apparent to one of ordinary skill in the art in light of the above teachings. It is therefore understood that the scope of the invention is not to be limited by the foregoing description, but rather is to be defined by the claims appended hereto.

What is claimed is:

1. A gravure ink binder composition for use in gravure ink formulations comprising the hydrocarbon/acrylic graft copolymer reaction product produced by reacting:
a) about 2% to about 63% by total weight of the reactants of dicyclopentadiene;
b) about 2% to about 63% by total weight of the reactants of a member selected from the group consisting of hydrocarbon monomers which undergo polymerization with dicyclopentadiene and combinations thereof;
c) about 33% to about 96% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are which undergo cycloaddition reaction with components a) and b); and
d) up to about 63% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;
at a temperature of from about 160°C. to about 300°C. for a time sufficient to produce the gravure ink binder composition.

2. The gravure ink binder composition of claim 1 which further comprises the reaction product produced by reacting:
a) about 10% to about 40% by total weight of the reactants of dicyclopentadiene;
b) about 10% to about 40% by total weight of the reactants of a member selected from the group consisting of hydrocarbon monomers which undergo polymerization with dicyclopentadiene and combinations thereof;
c) about 40% to about 80% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are which undergo cycloaddition reaction with components a) and b); and
d) up to about 40% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;
at a temperature of from about 220°C. to about 280°C. for a time sufficient to produce the gravure ink binder composition.

3. The gravure ink binder composition of claim 1 wherein said alcohol is a member selected from the group consisting of alcohols which undergo an insertion reaction across a norbornyl site, alcohols which undergo an esterification reaction with an acid group, alcohols which undergo an esterification reaction with an acid equivalent functional group, and combinations thereof.

4. The gravure ink binder composition of claim 1 wherein said alkyl amine is a member selected from the group consisting of alkyl amines which undergo an insertion reaction across a norbornyl site, alkyl amines which undergo an esterification reaction with an acid group, alkyl amines which undergo an esterification reaction with an acid equivalent functional group, and combinations thereof.

5. The gravure ink binder composition of claim 1 wherein said α,β-unsaturated carboxylic acid is a member selected from the group consisting of α,β-unsaturated carboxylic acids which undergo an insertion reaction across a norbornyl site, α,β-unsaturated carboxylic acids which undergo an esterification reaction with an acid group, α,β-unsaturated carboxylic acids which undergo an esterification reaction with an acid equivalent functional group, α,β-unsaturated carboxylic acids which undergo a Diels-Alder addition reaction, α,β-unsaturated carboxylic acids which undergo an ene-reaction, and combinations thereof.

6. The gravure ink binder composition of claim 1 wherein said α,β-unsaturated carboxylic diacid is a member selected from the group consisting of α,β-unsaturated carboxylic diacids which undergo an insertion reaction across a norbornyl site, α,β-unsaturated carboxylic diacids which undergo an esterification reaction with an acid group, α,β-unsaturated diacids which undergo an esterification reaction with an acid equivalent functional group, α,β-unsaturated carboxylic diacids which undergo a Diels-Alder addition reaction, α,β-unsaturated carboxylic diacids which undergo an ene-reaction, and combinations thereof.

7. The gravure ink binder composition of claim 1 wherein said α,β-unsaturated carboxylic anhydride is a member selected from the group consisting of α,β-unsaturated carboxylic anhydrides which undergo an insertion reaction across a norbornyl site, α,β-unsaturated carboxylic anhydrides which undergo an esterification reaction with an acid group, α,β-unsaturated anhydrides which undergo an esterification reaction with an acid equivalent functional group, α,β-unsaturated carboxylic anhydrides which undergo a Diels-Alder addition reaction, α,β-unsaturated carboxylic anhydrides which undergo an ene-reaction, and combinations thereof.

8. The gravure ink binder composition of claim 1 wherein said fatty acid is a member selected from the group consisting of fatty acids which undergo an insertion reaction across a norbornyl site, fatty acids which undergo an esterification reaction with an acid group, fatty acids which undergo an esterification reaction with an acid equivalent functional group, fatty acids which undergo a Diels-Alder addition reaction, fatty acids which undergo an ene-reaction, and combinations thereof.

9. The gravure ink binder composition of claim 1 wherein said fatty acid compound is a member selected from the group consisting of fatty acid compounds which undergo an insertion reaction across a norbornyl site, fatty acid compounds which undergo an esterification reaction with an acid group, fatty acid compounds which undergo an esterification reaction with an acid equivalent functional group, fatty acid compounds which undergo a Diels-Alder addition reaction, fatty acid compounds which undergo an ene-reaction, and combinations thereof.

10. The gravure ink binder composition of claim 1 wherein said rosin acid is a member selected from the group consisting of tall oil rosin, gum rosin, wood rosin, and combinations thereof.

11. The gravure ink binder composition of claim 1 wherein said mononuclear phenol is a member selected from the group consisting of mononuclear phenols which undergo an insertion reaction across a norbornyl site, mononuclear phenols which undergo an esterification reaction with an acid group, mononuclear phenols which undergo an esterification reaction with an acid equivalent functional group, and combinations thereof.

12. The gravure ink binder composition of claim 1 wherein said polynuclear phenol is a member selected from the group consisting of polynuclear phenols which undergo an insertion reaction across a norbornyl site, polynuclear phenols which undergo an esterification reaction with an acid group, polynuclear phenols which undergo an esterification reaction with an acid equivalent functional group, and combinations thereof.

13. The gravure ink binder composition of claim 1 wherein said resole is a member selected from the group consisting of resoles which undergo an insertion reaction across a norbornyl site, resoles which undergo an esterification reaction with an acid group, resoles which undergo an esterification reaction with an acid equivalent functional group, and combinations thereof.

14. The gravure ink binder composition of claim 1 wherein said novolac is a member selected from the group consisting of novolacs which undergo an insertion reaction across a norbornyl site, novolacs which undergo an esterification reaction with an acid group, novolacs which undergo an esterification reaction with an acid equivalent functional group, and combinations thereof.

15. The gravure ink binder composition of claim 1 wherein said aldehyde is a member selected from the group consisting of paraformaldehyde, formaldehyde, and combinations thereof.

16. A gravure ink composition comprising solvent, colorant, and the binder composition of claim 1.

17. A gravure ink binder composition for use in gravure ink formulations comprising the hydrocarbon/acrylic hybrid graft copolymer reaction product produced by:
1) reacting
a) about 2% to about 63% by total weight of the reactants of dicyclopentadiene;
b) about 2% to about 63% by total weight of the reactants of a member selected from the group consisting of hydrocarbon monomers which undergo polymerization with dicyclopentadiene and combinations thereof; and
c) about 33% to about 96% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are which undergo cycloaddition reaction with components a) and b);
at a temperature of from about 160°C. to about 300°C. for a time sufficient to produce a resin composition; and
2) further reacting:
a) about 35% to about 98% by total weight of the reactants of said resin composition, and
b) about 2% to about 65% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;
at a temperature of from about 160°C. to about 300°C. for a time sufficient to produce the gravure ink binder composition.

18. The gravure ink binder composition of claim 17 which further comprises:
1) reacting
a) about 10% to about 40% by total weight of the reactants of dicyclopentadiene;
b) about 10% to about 40% by total weight of the reactants of a member selected from the group consisting of hydrocarbon monomers which undergo polymerization with dicyclopentadiene and combinations thereof; and
c) about 40% to about 80% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are which undergo cycloaddition reaction with components a) and b);
at a temperature of from about 220°C. to about 280°C. for a time sufficient to produce a resin composition, and
2) further reacting
b) about 50% to about 80% by total weight of the reactants of said resin composition, and
b) about 20% to about 50% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;
at a temperature of from about 220°C. to about 280°C. for a time sufficient to produce the gravure ink binder composition.

19. A gravure ink composition comprising solvent, colorant, and the gravure ink binder composition of claim 17.

20. A gravure ink binder composition for use in gravure ink formulations comprising the hydrocarbon/acrylicgraft copolymer reaction product produced by reacting:
a) about 2% to about 63% by total weight of the reactants of dicyclopentadiene;
b) about 2% to about 63% by total weight of the reactants of a member selected from the group consisting of hydrocarbon resins, modified hydrocarbon resins, and combinations thereof;
c) about 33% to about 96% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are which undergo cycloaddition reaction with components a) and b); and
d) up to about 63% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;
at a temperature of from about 140°C. to about 300°C. for a time sufficient to produce the gravure ink binder composition.

21. The gravure ink binder composition of claim 20 which further comprises reacting:
a) about 10% to about 40% by total weight of the reactants of dicyclopentadiene;
b) about 10% to about 40% by total weight of the reactants of a member selected from the group consisting of hydrocarbon resins, modified hydrocarbon resins, and combinations thereof;
c) about 40% to about 80% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are which undergo cycloaddition reaction with components a) and b); and
d) up to about 40% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;
at a temperature of from about 180°C. to about 260°C. for a time sufficient to produce the gravure ink binder composition.

22. A gravure ink composition comprising solvent, colorant, and the ink binder composition of claim 20.

23. A gravure ink binder composition for use in gravure ink formulations comprising the hydrocarbon/acrylic graft copolymer resin reaction product produced by:
1) reacting
a) about 2% to about 63% by total weight of the reactants of dicyclopentadiene;
b) about 2% to about 63% by total weight of the reactants of a member selected from the group consisting of hydrocarbon resins, modified hydrocarbon resins, and combinations thereof; and
c) about 33% to about 96% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are which undergo cycloaddition reaction with components a) and b);
at a temperature of from about 140°C. to about 300°C. for a time sufficient to produce a resin composition; and
2) further reacting:
a) about 35% to about 98% by total weight of the reactants of said resin composition, and
b) about 2% to about 65% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;
at a temperature of from about 140°C. to about 300°C. for a time sufficient to produce the gravure ink binder composition.

24. The gravure ink binder composition of claim 23 which further comprises:
1) reacting
a) about 10% to about 40% by total weight of the reactants of dicyclopentadiene;
b) about 10% to about 40% by total weight of the reactants of a member selected from the group consisting of hydrocarbon resins, modified hydrocarbon resins, and combinations thereof; and
c) about 40% to about 80% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are which undergo cycloaddition reaction with components a) and b);
at a temperature of from about 180°C. to about 260°C. for a time sufficient to produce a resin composition, and
2) further reacting
a) about 50% to about 80% by total weight of the reactants of said resin composition, and
b) about 20% to about 50% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;
at a temperature of from about 180°C. to about 260°C. for a time sufficient to produce the gravure ink binder composition.

25. A gravure ink composition comprising solvent, colorant, and the binder composition of claim 23.
